(19) United States
(12) Patent Application Publication
(10) Pub. No.: US 2020/0210534 A1
(43) Pub. Date: Jul. 2, 2020

(54) INTEGRATED CIRCUITRY DEVELOPMENT SYSTEM, INTEGRATED CIRCUITRY DEVELOPMENT METHOD, AND INTEGRATED CIRCUITRY

(71) Applicant: Realtek Semiconductor Corporation, Hsinchu (TW)

(72) Inventors: Chihtung CHEN, San Diego, CA (US); Sa-Chia Ho, Zhubei City (TW); Hong-Chang Wu, New Taipei (TW); Hsin-Chen Chen, Kaohsiung (TW)

(21) Appl. No.: 16/236,758

(22) Filed: Dec. 31, 2018

(51) Int. Cl. G06F 17/50

(52) U.S. Cl. CPC G06F 17/504; G06F 17/5027

(57) ABSTRACT

An integrated circuitry development system includes an integrated circuitry and a programmable circuitry. The programmable circuitry is configured to execute a function of a hardware circuit to be added to the integrated circuitry. The integrated circuitry includes a memory and a first circuit. The memory is configured to store a computer program code, in which the computer program code includes a first part and a second part. The first circuit and the programmable circuitry are configured to execute the first part and the second part of the computer program code, respectively, in order to generate a simulation result for verifying at least one of the function of the hardware circuit and the second part of the computer program code.

### BACKGROUND

### Technical Field

The present disclosure relates to an integrated circuitry development system, an integrated circuitry development method, and an Integrated circuitry. More particularly, the present disclosure relates to an integrated circuitry development system, an integrated circuitry development method, and an integrated circuitry for accelerating SoC (system on chip) based software development.

### Description of Related Art

Before the integrated circuitry (IC) is commercialized, it usually undergoes several revisions. The revisions may include adding, deleting, or correcting some functions of the IC hardware. During the process, the software developers have to cooperate with the changes of the hardware. Therefore, a platform that is the same or similar to the integrated circuitry executing the software that is under development is in need. Various methods for simulating Integrated circuits of a chip have been developed. However, in current methods, the simulation procedure requires a long time (e.g., days, and sometimes weeks) to obtain a persuasive simulation result.

### SUMMARY

Some aspects of the present disclosure are to provide an integrated circuitry development system. The integrated circuitry development system includes an integrated circuitry and a programmable circuitry. The programmable circuitry is configured to execute a function of a hardware circuit to be added to the integrated circuitry. The integrated circuitry includes a memory and a first circuit. The memory is configured to store a computer program code, in which the computer program code includes a first part and a second part. The first circuit and the programmable circuitry are configured to execute the first part and the second part of the computer program code, respectively, in order to generate a simulation result for verifying at least one of the function of the hardware circuit or the second part of the computer program code.

Some aspects of the present disclosure are to provide an integrated circuitry development method. The integrated circuitry development method includes the following operations: storing a computer program code, by a memory of an integrated circuitry, in which the computer program code includes a first part and a second part; and executing the first part and the second part of the computer program code by a first circuit of the integrated circuitry and a programmable circuitry coupled to the integrated circuitry, respectively, in order to generate a simulation result for verifying at least one of a function of a hardware circuit or the second part of the computer program code. The programmable circuitry is configured to execute the function of a hardware circuit to be added to the integrated circuitry.

Some aspects of the present disclosure are to provide an integrated circuitry. The integrated circuitry includes a first circuit and a memory. The memory is configured to store a computer program code. The computer program code includes a first part and a second part. The first part is executed by the first circuit configured to generate a first execution result. The second part executed by a programmable circuitry coupled to the integrated circuitry so as to generate a second execution result, wherein a simulation result is generated, by the first circuit, according to the first execution result and the second execution result for verifying at least one of a function of a hardware circuit or the second part of the computer program code.

As described above, the integrated circuitry development system, the integrated circuitry development method, and the integrated circuitry provided herein enable the software developers develop new software on the hardware platform. In addition to benefiting from the characteristics of the hardware platform, the simulation time is shortened, and the difficulty of integrating the new software and the new version IC is reduced due to the hardware platform that is approximate to the new version IC, so as to accelerate the development process of the SoC based software.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of an integrated circuitry development system, according to some embodiments of the present disclosure.

FIG. 2 is a flow chart of an integrated circuitry development method according to some embodiments of the present disclosure.

FIG. 3 is a flow chart of an operation in FIG. 2 according to some embodiments of the present disclosure.

### DETAILED DESCRIPTION

The following embodiments are disclosed with accompanying diagrams for detailed description. For illustration clarity, many details of practice are explained in the following descriptions. However, it should be understood that these details of practice do not intend to limit the present disclosure. That is, these details of practice are not necessary in parts of embodiments of the present embodiments. Furthermore, for simplifying the drawings, some of the conventional structures and elements are shown with schematic illustrations.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

In this document, the term “coupled” may also be termed as “electrically coupled,” and the term “connected” may be termed as “electrically connected.” ‘Coupled’ and “connected” may mean “directly coupled” and “directly connected” respectively, or “indirectly coupled” and “indirectly connected” respectively. “Coupled” and “connected” may also be used to indicate that two or more elements cooperate or interact with each other.

In this document, the term “circuitry” may indicate a system formed with one or more circuits. The term “circuit” may indicate an object, which is formed with one or more transistors and/or one or more active/passive elements based on a specific arrangement, for processing signals.

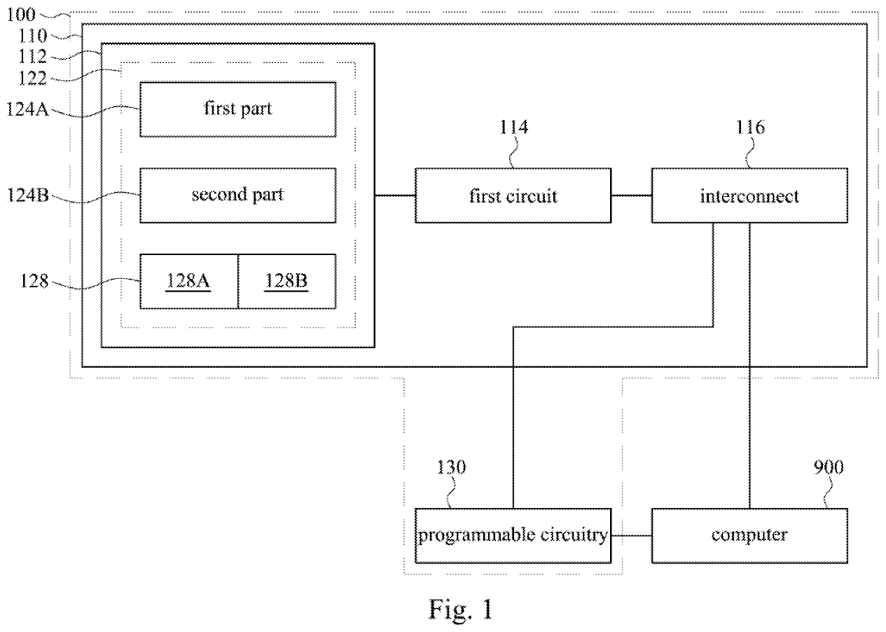

Reference is made to FIG. 1. FIG. 1 is a schematic diagram of an integrated circuitry development system 100 according to some embodiments of the present disclosure.

As shown in FIG. 1, the integrated circuitry development system 100 includes an integrated circuitry 110 and a programmable circuitry 130. The Integrated circuitry 110 includes a memory 112, a first circuit 114, and an Interconnect 116. In the connection relationship, the memory 112 is coupled to the first circuit 114, and the first circuit 114 is coupled to the interconnect 116. The programmable circuitry 130 is coupled to the integrated circuitry 110 through the interconnect 116. The programmable circuitry 130 is configured to execute a function of a hardware circuit to be added to the integrated circuitry.

In various embodiments, the programmable circuitry 130 may be implemented with a circuit that is capable to be reprogrammed and is able to execute the function of a hardware circuit, such as a field-programmable gate array (FPGA). Various circuits or units to implement the programmable circuitry 130 are within the contemplated scope of the present disclosure.

In various embodiments, the first circuit 114 may be implemented with at least one processor circuits, a central processing unit (CPU), an application specific integrated circuit (ASIC), a multi-processor, a distributed processing system, or a suitable processing circuitry. Various circuits or units to implement the first circuit 114 are within the contemplated scope of the present disclosure.

The memory 112 stores at least one computer program code 122. For illustration, the memory 112 stores at least one computer program code 122 encoded with a set of instructions. The first circuit 114 may execute the at least one computer program code 122 stored in the memory 112, and the operations of the hardware of the integrated circuits and/or the programmable circuitry 130 are able to be automatically performed.

The Interconnect 116 receives and/or transmits signals or commands (not shown) from various devices or circuits. Accordingly, the integrated circuitry 110 may be manipulated with the signals or commands received by the interconnect 116.

In some embodiments, the computer program code 122 stored in the memory 112 includes a first part 124A and a second part 124B. The first part is the original part of the computer program code or the last version of the computer program code, and the second part is the modified part/newly added part of the computer program code.

The first circuit 114 and the programmable circuitry 130 are configured to execute the first part 124A and the second part 124B of the computer program code 122, respectively, in order to generate a simulation result for verifying at least one of the function of the hardware circuit or the second part 1248 of the computer program code 122.

To be more detailed, in some embodiments, the first part 124A of the computer program code 122 is executed by the first circuit 114, and the second part 124B of the computer program code 122 is executed by the programmable circuitry 130.

When a developer wants to develop a new version of the software, the added/modified hardware circuit will be burned to the programmable circuitry 130. The new version of the software corresponds to the second part 1248 of the computer code 122. When the developer develops a new version of the software, since the old version of the integrated circuitry 110 is compatible, the old/original part of the software, that is, the first part 124A, may work directly on the original version of the integrated circuitry 110. When adding/modifying the software, since the original integrated circuitry 110 has reserved the corresponding memory interval and the memory interval is directly mapped to the new/modified hardware circuit in the programmable circuitry 130, the new/modified software, that is, the second part 124B, is expected to work directly by the programmable circuitry 130.

In some embodiments, the memory 112 includes a specified block 128. The specified block 128 is configured to indicate whether to execute the computer program code 122 by the first circuit 114 or the programmable circuitry 130. In some embodiments, the specified block 128 is within the computer program code 122.

To be more detailed, the specified block 128 includes several sub specified blocks 128A and 128B, in which the sub specified block 128A corresponds to the first part 124A of the computer code 122, and the sub specified block 128B corresponds to the second part 124B of the computer code 122. The sub specified block 128A stores a first data, so as to indicate the first part 124A to be executed by the first circuit 114. On the other hand, the sub specified block 128B stores a second data, so as to indicate the second part 124B to be executed by the programmable circuitry 130. The first part 124A and the second part 124B may be executed by the first circuit 114 of the programmable circuitry 130 according to the specified block 128.

In some embodiments, the Integrated circuitry 110 and the programmable circuitry 130 couple to a computer 900 respectively. After execution, the programmable circuitry 130 transmits a first execution result to the computer 900 or the integrated circuitry 110, and the integrated circuitry 110 transmits a second execution result to the computer 900 so as to generate the simulation result by the computer 900.

In some other embodiments, the programmable circuitry 130 transmits the first execution result to the integrated circuitry 110, and the first circuit 114 generates the second execution result. Then, the first circuit 114 generates the simulation result according to the first execution result and the second execution result.

In some embodiments, the simulation result further includes the determination of whether an error occurs in the hardware circuit of the programmable circuitry 130 or the second part 1248 of the computer program code 122. That is, when an error occurs in the programmable circuitry 130, the first execution result may show that an error occurs in the programmable circuitry 130, and the user may know that there is an error with the function of the new/modified hardware. The user may modify the hardware circuit of the programmable circuitry 130, and the simulation result may be regenerated with the revised version of the hardware circuit.

On the other hand, when an error occurs in the second part 124B of the computer program code 122, the second execution result may show that an error occurs in the second part 124B of the computer program code 122, and the user may know that there is an error with the new/modified software. The user may modify the second part 124B of the computer program code 122, and the simulation result may be regenerated with the second part 1248 of the computer program code 122.

In some embodiments, the integrated circuitry 110 and the programmable circuitry 130 communicates with each other through the interconnect 116 according to a communication protocol. The communication protocol may be, but not limited to I²C (Inter-Integrated Circuit), SPI (Serial Peripheral Interface), etc. In some embodiments, the communication protocol synchronizes the actions of the integrated circuitry 110 and the programmable circuitry 130. For example, when one end, such as the integrated circuitry 110, of the interconnect 116 reads and writes to the memory block, the other end, such as the programmable circuitry 130, of the interconnect 116 is expected to execute the same read and write actions.

To be more detailed the integrated circuitry 110 and the programmable circuitry 130 operate according to different clocks, for the developer, the integrated circuitry 110 operates at an expected operating frequency, whereas the programmable circuitry 130 operates at an frequency after the programmable circuitry 130 is synthesized. Therefore, the developer needs to synchronize signals between both ends of the interconnect 116 with an asynchronous circuit.

According to the integrated circuitry development system 100 providing above, since the new version of the computer program code 122 runs on the integrated circuitry 110, the operating speed is equal to the operating frequency of the integrated circuitry 110, and the developer can instantly confirm the operation status of the new version of the computer program code 122. Since the software development is based on the physical integrated circuitry, the signal can be output from the hardware platform, such as the integrated circuitry development system 100, for the developer to confirm, or the feedback signal in the hardware platform can be received immediately. Furthermore, the feedback signal may be only available in physical integrated circuitry, such as a signal from analog circuits. Since the new/modified hardware circuit is implemented in the programmable circuitry 130, when any problem occurs in the software development process, the hardware circuit may be adjusted. Finally, since the hardware platform is constructed with the configuration of the new developed integrated circuitry, after the new software is able to run normally on the hardware platform, the developer may transplant the new computer program code to the new Integrated circuitry in the shortest time.

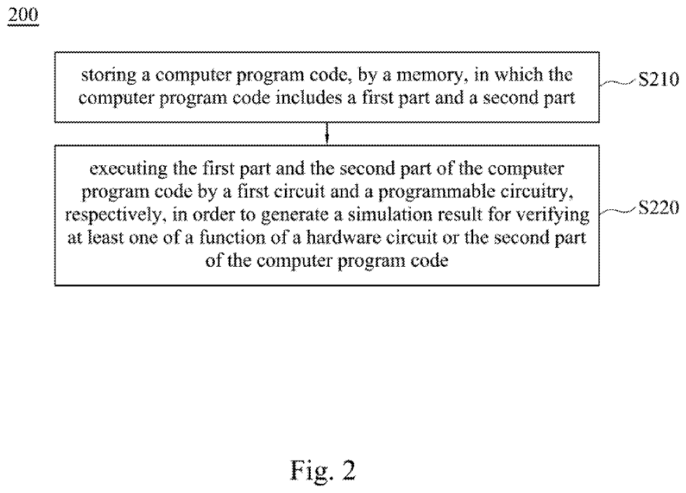

Reference is made to FIG. 2. FIG. 2 is a flow chart of an integrated circuitry development method 200, according to some embodiments of the present disclosure. For ease of understanding, the integrated circuitry development method 200 is described below with reference to FIG. 1.

In operation 8210, storing a computer program code, by a memory, in which the computer program code includes a first part and a second part.

For example, the memory 112, as illustrated in FIG. 1, stores a computer program code 122, which Includes a first part 124A and a second part 124B. In some embodiments, the first part 124A is the original part of the computer program code 122 or the last version of the computer program code, and the second part is the modified part/newly added part of the computer program code. In some embodiments, the computer 900 may transmits the computer program code 122 to the integrated circuitry 110 so as to store the computer program code 122. It should be noted that, by this time, the version of the hardware of the integrated circuit 110 is corresponding to the original version of the software.

In operation 8220, executing the first part 124A and the second part 124B of the computer program code 122 by a first circuit 114 and a programmable circuitry 130, respectively, in order to generate a simulation result for verifying at least one of a function of a hardware circuit or the second part 124B of the computer program code 122.

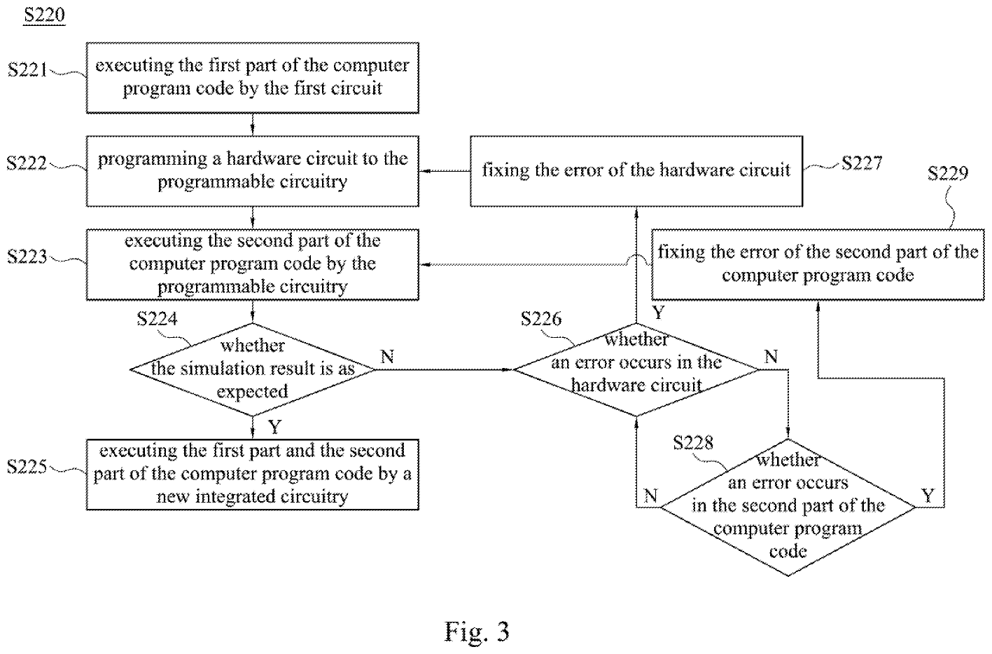

Reference is made to FIG. 3. FIG. 3 is a flow chart of operation S220 in FIG. 2 according to some embodiments of the present disclosure. For ease of understanding, the integrated circuitry development method 200 is described below with reference to FIG. 1.

In operation 8221, executing the first part 122A of the computer program code 122 by the first circuit 114.

In operation S222, programming a hardware circuit to the programmable circuitry 130. In some embodiments, operation S222 may be performed by the computer 900.

In operation S223, executing the second part 122B of the computer program code 122 by the programmable circuitry 130.

In operation S224, determining whether the simulation result is as expected. In some embodiments, operation S224 may be performed by the computer 900. If the simulation result is as expected, operation S225 is performed. The simulation result is generated according to the execution result of operation S221 to S224. If the simulation result is not as expected, operation 8226 is performed.

In operation S225, executing the first part 122A and the second part 122B of the computer program code 122 by a new integrated circuitry. The new integrated circuitry combines the first circuit 114 and the hardware circuit which is previously programmed to the programmable circuitry 130. That is, when the simulation result meets the expectation of the user, the new integrated circuitry corresponding to the new software may be implemented, and the development process may be ended.

In operation S226, determining whether an error occurs in the hardware circuit. In some embodiments, operation S226 may be performed by the computer 900. If it is determined that the error occurs in the hardware circuit, operation 3227 is performed. If it is determined that the error does not occur in the hardware circuit, operation 3228 is performed.

In operation 8227, fixing the error of the hardware circuit. In some embodiments, operation 8227 may be performed by the computer 900. After the error of the hardware circuit is revised, operations S222 to 8223 are performed again to generate the simulation result.

In operation S228, determining whether an error occurs in the second part 122B of the computer program code 122. In some embodiments, operation 8228 may be performed by the computer 900. If it is determined that the error occurs in the second part 1228 of the computer program code 122, operation 8229 is performed. If it is determined that the error does not occur in the second part 1228 of the computer program code 122, operation 8228 is performed.

In operation 8229, fixing the error of the second part 1228 of the computer program code 122. In some embodiments, operation 8229 may be performed by the computer 900. After the error of the second part 1228 of the computer program code 122 is revised, operation S223 is performed again to generate the simulation result.

During the development process, it is expected that the old version of the software is capable to work on the original integrated circuit, and the modified/added hardware will be burned on the programmable circuitry 130. According to the Integrated circuitry development method 200 mentioning above, if the new software works successfully with the modified/added hardware circuit (the programmable circuitry 130 and the integrated circuitry 110), then the new Integrated circuitry corresponding to the new software may be implemented, and the development process may be ended. On the other hand, if the operation results do not match the developer's expectations, with the simulation result, it may be confirmed whether an error occurs in the modified/added hardware circuit or whether an error occurs in the newly developed software.

Moreover, if there is a problem with the hardware, for example, if an error occurs in the programmable circuitry 130, after the hardware is corrected, the modified/added hardware circuit is burned to the programmable circuitry 130 again, and the previous process, such as operation S220, is continued to test the newly developed software and the modified/added hardware circuit again. On the other hand, if there is a problem with the software, for example, f an error occurs in the second part 124B of the computer program code 122, after the software is corrected, the computer program code 122 stored in the memory 112 will be renewed. The updated computer program code 122 is applied to the modified/added hardware circuit again and the previous process, such as operation S220, is continued to test the newly developed software and the modified/added hardware circuit again.

The above description of the integrated circuitry development method 200 includes exemplary operations, but the operations of the integrated circuitry development method 200 are not necessarily performed in the order described above. The order of the operations of the integrated circuitry development method 200 can be changed, or the operations can be executed simultaneously or partially simultaneously as appropriate, in accordance with the spirit and scope of various embodiments of the present disclosure.

As described above, the integrated circuitry development system, the integrated circuitry development method, and the integrated circuitry provided herein are able to shortened the simulation time, and the difficulty of integrating the new software and the new version IC is reduced due to the hardware platform that is approximate to the new version IC, and hence the development process of the SoC based software is accelerated.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

1. An integrated circuitry development system adapted for adding a function of a hardware circuit associated with an original function, wherein the integrated circuitry development system comprises:
an integrated circuitry configured to execute the original function; and
a programmable circuitry configured to execute the function of the hardware circuit to be added to the integrated circuitry,
wherein the programmable circuitry does not execute the original function; and
wherein the integrated circuitry comprises:
a memory configured to store a computer program code, wherein the computer program code comprises a first part and a second part; and
a first circuit, wherein the first circuit and the programmable circuitry are configured to execute the first part and the second part of the computer program code, respectively, in order to generate a simulation result for verifying at least one of the function of the hardware circuit and the second part of the computer program code.

2. The integrated circuitry development system of claim 1, wherein the simulation result further comprises whether an error occurs in the hardware circuit or the second part of the computer program code.

3. The integrated circuitry development system of claim 2, wherein the simulation result is regenerated with a revised version of the hardware circuit if it is determined that the error occurs in the hardware circuit; wherein the simulation result is regenerated with a revised version of the second part of the computer program code if it is determined that the error occurs in the second part of the computer program code.

4. The integrated circuitry development system of claim 1, wherein the memory comprises a specified block configured to indicate executing the computer program code by the first circuit or the programmable circuitry, wherein the specified block indicates the first part of the computer program code to be executed by the first circuit and indicates the second part of the computer program code to be executed by the programmable circuitry.

5. The integrated circuitry development system of claim 1, wherein the integrated circuitry further comprises:
an interconnect configured to communicate with the programmable circuitry according to a communication protocol, and an execution of the integrated circuitry and an execution of the programmable circuitry are synchronized according to the communication protocol.

6. The integrated circuitry development system of claim 1, wherein the programmable circuitry transmits a first execution result to a computer or the integrated circuitry, and the integrated circuitry transmits a second execution result to the computer so as to generate the simulation result.

7. The integrated circuitry development system of claim 1, wherein the first circuit is configured to execute the first part of the computer program code and the programmable circuitry is configured to execute the second part of the computer program code.

8. An integrated circuitry development method, adapted for adding a function of a hardware circuit associated with an original function, wherein the integrated circuitry development method comprises:
storing a computer program code, by a memory of an integrated circuitry, wherein the computer program code comprises a first part and a second part; and
executing the first part and the second part of the computer program code by a first circuit of the integrated circuitry and a programmable circuitry coupled to the integrated circuitry, respectively, in order to generate a simulation result for verifying at least one of a function of the hardware circuit and the second part of the computer program code, wherein the programmable circuitry is configured to execute the function of the hardware circuit to be added to the integrated circuitry, and the programmable circuitry does not execute the original function.

9. The integrated circuitry development method of claim 8, further comprising:
determining whether an error occurs in the hardware circuit or the second part of the computer program code.

10. The integrated circuitry development method of claim 9, further comprising:
revising the hardware circuit and regenerating the simulation result if it is determined that the error occurs in the hardware circuit; and
revising the second part of the computer program code and regenerating the simulation result if it is determined that the error occurs in the second part of the computer program code.

11. The integrated circuitry development method of claim 8, further comprising:
determining whether to execute the computer program code by the first circuit or the programmable circuitry according to a data stored in a specified block of the memory, wherein the specified block indicates the first part of the computer program code to be executed by the first circuit and indicates the second part of the computer program code to be executed by the programmable circuitry.

12. The integrated circuitry development method of claim 8, wherein the integrated circuitry and the programmable circuitry communicates with each other according to a communication protocol; an execution of the integrated circuitry and an execution of the programmable circuitry are synchronized according to the communication protocol.

13. The integrated circuitry development method of claim 8, further comprising:
transmitting, by the programmable circuitry, a first execution result to a computer or the integrated circuitry;
transmitting, by the integrated circuitry, a second execution result to the computer; and
generating the simulation result according to the first execution result and the second execution result.

14. The integrated circuitry development method of claim 8, further comprising:
executing, by the first circuit, the first part of the computer program code; and
executing, by the programmable circuitry, the second part of the computer program code.

15. An integrated circuitry, comprising:
a first circuit; and
a memory configured to store a computer program code, wherein the computer program code comprises:
a first part executed by the first circuit configured to generate a first execution result, wherein the first part corresponds to an original function executed by the first circuit; and
a second part executed by a programmable circuitry coupled to the integrated circuitry so as to generate a second execution result, wherein a simulation result is generated, by the first circuit, according to the first execution result and the second execution result for verifying at least one of a function of a hardware circuit and the second part of the computer program code, and the programmable circuitry does not execute the original function.

16. The integrated circuitry of claim 15, wherein the simulation result further comprises whether an error occurs in the hardware circuit or the second part of the computer program code.

17. The integrated circuitry of claim 16, wherein the simulation result is regenerated with a revised version of the hardware circuit if it is determined that the error occurs in the hardware circuit; wherein the simulation result is regenerated with a revised version of the second part of the computer program code if it is determined that the error occurs in the second part of the computer program code.

18. The integrated circuitry of claim 15, wherein the memory comprises a specified block configured to indicate executing the computer program code by the first circuit or the programmable circuitry; wherein the specified block indicates the first part of the computer program code to be executed by the first circuit and indicates the second part of the computer program code to be executed by the programmable circuitry.

19. The integrated circuitry of claim 15, wherein the integrated circuitry and the programmable circuitry communicate with each other according to a communication protocol; an execution of the integrated circuitry and an execution of the programmable circuitry are synchronized according to the communication protocol.

20. The integrated circuitry of claim 15, further comprising:
an interconnect configured to communicate with the programmable circuitry according to a communication protocol.
